(19) United States
(12) Patent Application Publication
(10) Pub. No.: US 2026/0036450 A1
(43) Pub. Date: Feb. 5, 2026

(54) SENSOR MODULE FOR A MODULAR CONNECTOR

(71) Applicant: Stäubli Electrical Connectors AG, Allschwil (CH)

(72) Inventors: Christian Alexander Michael GYSIN, Gempen (CH); Ana GAGO BENITEZ, Lampenberg BL (CH); Benedikt OHM, Lörrach-Haagen (DE); Guowei LIANG, Hangzhou City (CN); Chengcheng ZHANG, Hangzhou (CN); Liming ZHU, Hangzhou, Zhejiang (CN)

(73) Assignee: Stäubli Electrical Connectors AG, Allschwil (CH)

(21) Appl. No.: 18/997,366

(22) PCT Filed: Jul. 17, 2023
(86) PCT No.: PCT/EP2023/069765

§ 371 Date: Jan. 21, 2025

(30) Foreign Application Priority Data
Jul. 22, 2022 (CN) 22186487.9
Jul. 22, 2022 (CN) 22186490.3

(51) Int. Cl. G01D 11/24; G01D 21/02; H01R 13/518

(52) U.S. Cl. CPC G01D 11/245; G01D 21/02; H01R 13/518

(57) ABSTRACT

A sensor module (1) for a modular connector (2), in particular for a modular electrical and/or fluidic connector, having a carrier housing (3) with a receiving space (4) that is accessible via an opening (5) and that is closed with walls (6) and with an engagement structure (7) arranged on the outer side (8) of the carrier housing (3), and a sensor element (9) having a printed circuit board (10) and at least one sensor (11) to measure a physical property. The at least one sensor (11) is arranged on the printed circuit board (10). The printed circuit board (10) is mounted within the receiving space (4) to the carrier housing (3) and extends from the receiving space (4) through the opening (5) out of the receiving space (4).

### TECHNICAL FIELD

The present invention relates to a sensor module for a modular connector according to claim 1, an identification arrangement according to claim 10 and a modular connector according to claim 13 as well as to a connector system according to claim 16.

### PRIOR ART

WO 2020/011309 discloses a modular connector. The modular connector comprises several modules with different connector elements. The modular connector comprises a module, which has a switch to provide an electrical signal to a control unit such as a programmable logic controller.

DE 10 2015 105 262 discloses a sensor module for an electrical connector.

### SUMMARY OF THE INVENTION

It is an object of the present invention to provide a sensor module, which has enhanced properties for a sensor structure.

This object is solved by the sensor module of claim 1. According to claim 1, the sensor module for a modular connector, in particular for a modular electrical and/or fluidic connector, comprises a carrier housing with a receiving space that is accessible via an opening and that is closed with walls and with an engagement structure arranged on the outer side of the carrier housing, and a sensor element comprising a printed circuit board and at least one sensor to measure a physical property, wherein the at least one sensor is arranged on the printed circuit board. Said printed circuit board is mounted within the receiving space to the carrier housing and extends from the receiving space through the opening out of the receiving space.

This means with other words, that the printed circuit board is partially arranged within the receiving space and extends out of the receiving space.

The arrangement of the printed circuit board as described has the advantage that the at least one sensor can be arranged based on its properties. For example: A sensor which needs to be protected from ambient influences will be placed within the receiving space. A sensor which requires a certain air volume for its functioning can be placed outside the receiving space.

A further advantage is that the part of the printed circuit board that extends out of receiving space is typically encompassed with air having a lower temperature than air in the receiving space. Although this part is usually encompassed by a housing of the plug, the air volume in that housing is typically larger than the air volume within the receiving space and therefore cooling can be effected.

A further advantage is that the assembly of the sensor module is fairly simple, as the part of the printed circuit board that extends out of the receiving space can be gripped and therefore the printed circuit board can be manipulated very easily.

With regard to the modular connector as outlined below the sensor module has the further advantage that the sensor module can be placed at any position. Therefore, during assembly of such a connector the sensor module can for example be placed at the most sensible location or at a location which is of particular interest.

Preferably the printed circuit board extends with a first section into the receiving space and with a second section out of the receiving space, wherein as seen perpendicular to the side of the carrier housing in which the opening is placed, the length of the first section is smaller or larger or equal compared to the length of the second section.

In a first variant at least one of said sensors is arranged on the first section. In a second variant at least one of said sensor elements is arranged on the second section. In a third variant at least one of said sensors is arranged on the first section and at least one of said sensor elements is arranged on the second section.

Said walls, which define the receiving space, comprise a front wall and sidewalls extending from said front wall. The opening through which the receiving space is accessible is encompassed by said sidewalls. Preferable the front wall has a rectangular form. Preferably said sidewalls extend perpendicularly to said front wall. The receiving space has preferably the shape of a quader.

Preferably a first width of the receiving space is equal to the width of the printed circuit board and wherein a second width of the receiving space, that is oriented perpendicular to the first width, is larger than the maximum thickness of the printed circuit board.

Preferably, the width of the receiving space is provided such that there is no contact between the at least one sensor mounted on the printed circuit board and the inner side of said walls facing the receiving space.

Preferably said carrier housing is provided with a first carrier housing part and with a second carrier housing part, wherein the first carrier housing part and the second carrier housing part are preferably connected together by means of at least one connection element.

The connection element can be at least one screw and a corresponding nut. Alternatively, the connection element can also be provided with at least one snap-in tab on one of the carrier housing parts that engages in a corresponding opening on the other of the carrier housing parts. Alternatively it may also be possible that an alignment structure with a pin and an opening is provided on the carrier housing parts and that the carrier housing part are held together by the frame structure and the functional modules as mentioned below in connection with the connector.

Alternatively said carrier housing is provided as a single piece element.

Preferably, the printed circuit board is mounted by means of a form fit and/or a force fit connection with the carrier housing. In particular, the carrier housing or one of the above mentioned carrier housing part comprises at least one, preferably two, embossment elements which engage into at least one, preferably two indentations of the printed circuit board.

Preferably the printed circuit board comprises at least one communication module which is preferably located outside the receiving space. Said communication module can be a mechanical connection interface to connect a connector of a signal cable and/or said communication module can be a wireless communication module.

Preferably, the printed circuit board comprises a micro controller and/or a battery.

Preferably a first engagement structure is arranged on a first wall of said walls and a second engagement structure is arranged on a second wall of said walls, which second wall is arranged opposite the first wall. Preferably, the engagement structure is an embossment extending away from the outer side of said wall. Alternatively, the engagement structure is provided by a bracket element or a clip element.

Preferably the at least one sensor is chosen from the group of
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or
an acceleration sensor configured to measure an acceleration, which is said physical property; and/or
an mating cycle sensor configured to measure the number of mating cycles, which are said physical property; and/or
a flow sensor configured to measure a volume flow, which is said physical property.

The mating cycle sensor is preferably a near field communication sensor or a radio frequency identification device. With those devices it may also be possible to identify a connector.

In the specific embodiments it is possible that some of the sensors are provided in a single sensor device. It is for example possible to integrate a temperature sensor and the humidity sensor in a single sensor device.

Preferably, the ambient temperature is the ambient temperature in a housing.

The term “a specific temperature” is to be understood that the temperature at a specific location is measured. For example at a contact element of the connection interface or at a specific location on the housing.

Preferably, the acceleration sensor measures the acceleration along at least one axis, preferably along three axes.

The list as mentioned above mentions one sensor per property. However, it is also possible to add more than one sensor to measure the same property.

An identification arrangement for a modular connector, in particular for a modular electrical and/or fluidic connector, comprises a first carrier housing with an active identification device and a second carrier housing with a passive identification device, wherein the active identification device is configured to identify the passive identification device,
wherein one of said carrier housings has a recess and the other of said carrier housings has a shaft, wherein the shaft and the recess are configured such that the shaft can be inserted into and received by the recess; and
wherein each of said carrier housing comprises an engagement structure.

Preferably the identification device is a radio frequency identification device. The passive identification device is provided by a chip and a coil. The chip and the coil are powered by the active sensor device such that with the active identification device it is possible to read the information stored on the passive identification device.

Preferably the active identification device and the passive identification device are arranged such on the respective carrier housing that identification becomes only possible, when the shaft is fully inserted into the recess. Alternatively, the active identification device and the passive identification device are arranged such on the respective carrier housing that identification becomes possible during the insertion of the shaft into the recess.

Preferably the first carrier housing and the second carrier housing have at least one wall at least partly delimiting a receiving space, wherein the at least one wall has an outer surface, which outer surface of said first carrier housing and which outer surface of said second carrier housing are in a flat engagement when the shaft is fully inserted into the recess or during insertion of the shaft into the recess, wherein said identification devices are arranged in the receiving space behind said outer surfaces.

In a preferred embodiment the active identification device is electrically connected to the at least one printed circuit board as mentioned above. Via this connection it is possible to transmit energy and/or data between the active identification device and the at least one printed circuit board.

A modular connector comprising at least one sensor module according to the description above, and/or at least one of said carrier housing of said one identification arrangement according to the description above. The modular connector further comprises at least one functional module and a bearing frame. The bearing frame having two frame elements with a frame side engagement structure and two connection elements, which frame elements and connection elements are arranged such to form an interior space.

Said at least one sensor module is arranged partly in said interior space and wherein the engagement structure of the sensor module engages with the frame side engagement structure.

Said at least one functional module are arranged partly in said interior space and wherein an engagement structure of the functional module engages with the frame side engagement structure.

Said carrier housing is arranged partly in said interior space and the engagement structure of the carrier housing engages with the frame side engagement structure.

Preferably the engagement structures of the sensor module, the functional module and said carrier housing are similar or substantially identical to each other such that they engage with the same bearing frame.

The functional module preferably comprises contact elements to establish a contact with a further modular connector. The contact elements can be electrical and/or fluidic contact elements. The contact elements are arranged a functional module carrier element which is, as mentioned above, also connected to the frame.

Said functional module preferably comprises a front side which defines a connection plane, wherein a front wall of the carrier housing extends in said plane. Preferably, the shaft of the first carrier housing or the second carrier housing, respectively extends away from said plane.

Preferably, the modular connector further comprises a connector housing, wherein the printed circuit board extends into the connector housing.

In one embodiment the frame side engagement structure is provided by a groove into which the above mentioned embossment engages. In an alternative embodiment the frame side engagement structure is provided by the frame as such, whereby the above mentioned bracket element or clip elements clamps the frame.

A connector system comprises a modular connector according to the description above and a corresponding modular connector having at least one functional module which can be connected to the functional module of the modular connecter, wherein at the corresponding position of the at least one sensor module, if present, at least one blind module is placed and/or wherein at the corresponding position of the at least one carrier housing, if present, said at least one other carrier housing is placed.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective view of a sensor module according to a preferred embodiment of the present invention;

FIG. 2 shows a first cross sectional view of the sensor module according to FIG. 1;

FIG. 3 shows a second cross sectional view of the sensor module according to FIGS. 1 and 2;

FIG. 4 shows a perspective sectional view of the sensor module according to FIGS. 1 to 3;

FIG. 5 shows a perspective view of a connector system comprising a modular connector with a sensor module according to FIGS. 1 to 3 and a corresponding modular connector;

FIG. 6 shows a cross-sectional view of the connector system according to FIG. 5; and

FIG. 7 shows a cross-sectional view of the connector system according to FIG. 5.

### DESCRIPTION OF PREFERRED EMBODIMENTS

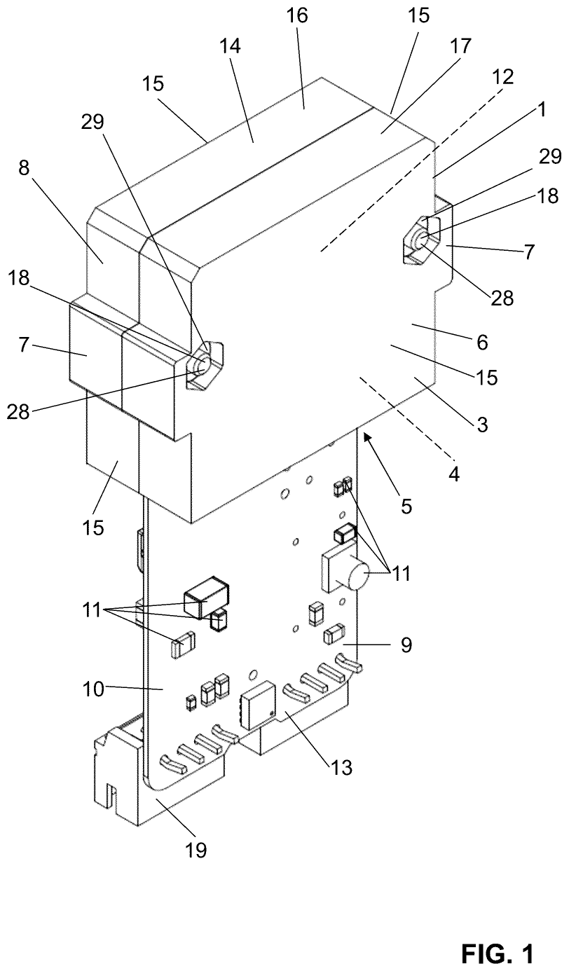

FIG. 1 shows a perspective view of a sensor module 1 for a modular connector 2. The modular connector 2 is preferably an electrical and/or fluidic connector.

The sensor module 1 comprises a carrier housing 3 and a sensor element 9.

The carrier housing 3 has a receiving space 4. The receiving space 4 serves receive the sensor element 9 partly. The receiving space 4 is accessible via an opening 5. Apart from the opening 5 the receiving space 4 is closed with walls 6. Further, an engagement structure 7 is arranged on the outer side 8 of the carrier housing 3.

The sensor element 9 comprises a printed circuit board 10 and at least one sensor 11 to measure a physical property. Examples of the at least one sensor 11 are mentioned below. The at least one sensor 11 is arranged on the printed circuit board 10.

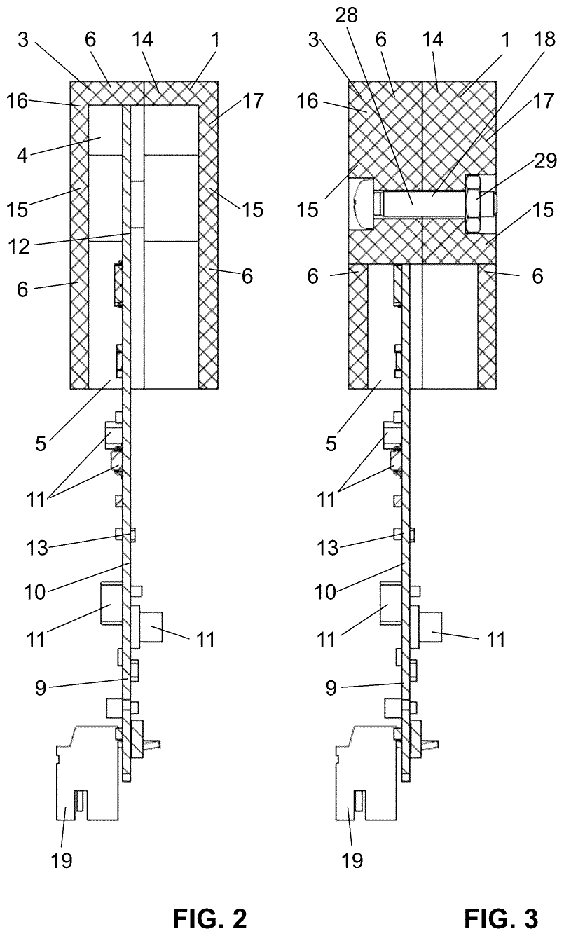

As it can be seen in FIGS. 2 and 3, said printed circuit board 10 is mounted within the receiving space 4 to the carrier housing 3 and extends from the receiving space 4 through the opening 5 out of the receiving space 4. In the present embodiment the printed circuit board 10 extends with a first section 12 into the receiving space 4 and with a second section 13 out of the receiving space 4. As seen perpendicular to the side of the carrier housing 3 in which the opening 5 is placed, the length of the first section 12 is smaller compared to the length of the second section 13. Other configurations are also possible.

In the present case some of the sensors are arranged on the first section 12 and are therefore also located within said receiving space 4. Furthermore, other sensors are arranged on the second section 13 and are therefore located outside said receiving space 4.

Preferably several sensors 11 are arranged on the printed circuit board 10. In the present case sensors 11 are arranged on both sides of the printed circuit board 10. It may also be possible to have only one side of the printed circuit board 10 is provided with the sensors.

As mentioned above, the carrier housing 3 comprises walls 6 which define said receiving space. In the present case, said walls comprise a front wall 14 and sidewalls 15 extending from said front wall 14. The opening 5 is encompassed by said sidewalls 15. The front wall 14 has a rectangular form and said sidewalls 15 extend preferably perpendicularly to said front wall 14.

In the present case said carrier housing 3 is provided with a first carrier housing part 16 and with a second carrier housing part 17, wherein the first carrier housing part 16 and the second carrier housing part 17 are connected together by means of at least one connection element 18. The at least one connection element 18 is in the present embodiment a screw 28 and a corresponding nut 29.

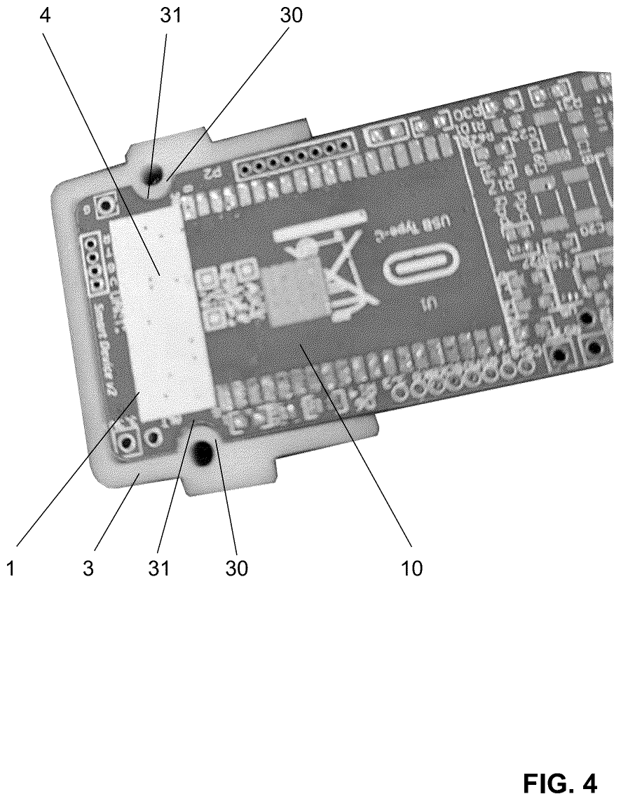

Preferably, the printed circuit board 10 is mounted by means of a form fit and/or a force fit connection with the carrier housing 3. From FIG. 4 the first carrier housing part 16 is shown. The first carrier housing part 16 comprises two embossments 30. The embossments 30 are arranged on opposite sides of the receiving space 4. The printed circuit board 10 comprises two indentations 31. The embossments 30 and the indentations 31 are provided such that the embossments 30 engage with the indentations 31. The engagement provides a mechanical connection between the first carrier housing part 16 and the printed circuit board 10. Likewise it is also possible to connect the printed circuit board in the same way to the second carrier housing part 17.

The printed circuit board 10 comprises at least one communication module 19. Preferably, the communication module 19 is located outside the receiving space 4. In the present embodiment said communication module 19 is a mechanical connection interface to connect a connector of a signal cable. Alternatively or additionally said communication module 19 is a wireless communication module.

Furthermore, the printed circuit board 10 comprises a micro controller and/or a battery.

As it can be seen from FIG. 1, a first engagement structure 7 is arranged on a first wall of said walls and a second engagement structure 7 is arranged on a second wall of said walls, which second wall is arranged opposite the first wall. The engagement structure 7 is an embossment extending away from the respective wall.

Preferably the at least one sensor is chosen from the group of:
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or an acceleration sensor configured to measure an acceleration, which is said physical property; and/or
an mating cycle sensor configured to measure the number of mating cycles, which are said physical property; and/or
a flow sensor configured to measure a volume flow, which is said physical property.

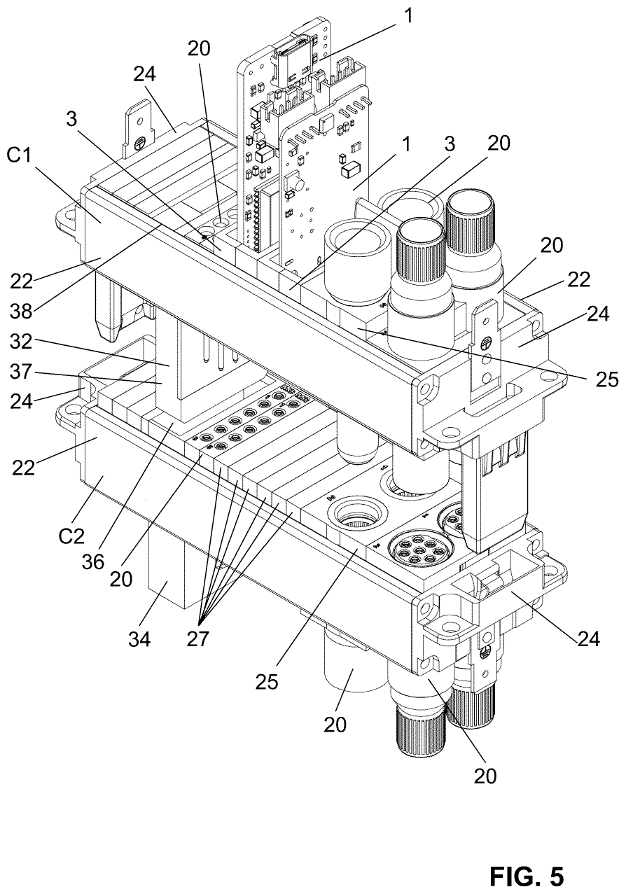

FIGS. 5 to 7 show a connector system with a modular connector C1 and a corresponding modular connector C2. Thereby the modular connector C1 and the corresponding modular connector C2 can be connected together.

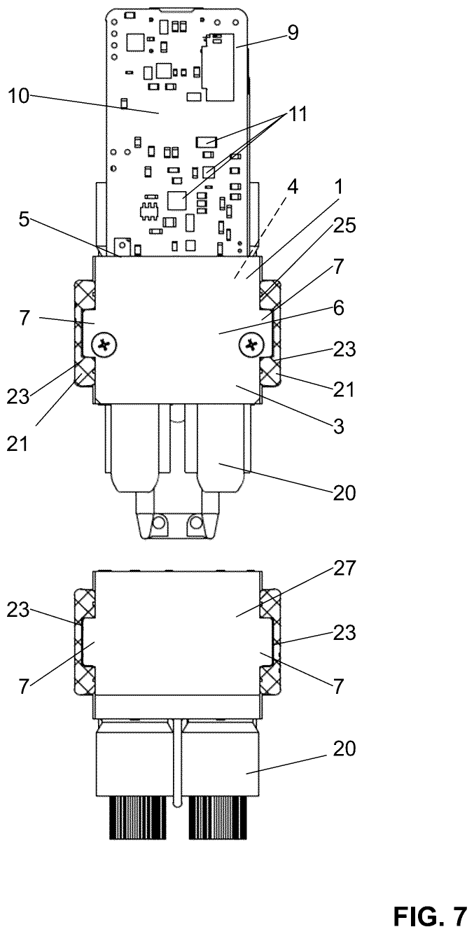

The modular connector C1 comprises at least one of the above described sensor module 1, at least one functional module 20 and a bearing frame 21. In the present case two sensor modules 1 are arranged. The bearing frame 21 has two frame elements 22 with a frame side engagement structure 23 and two connection elements 24, which frame elements 22 and connection elements 24 are arranged such to form an interior space 25. Said at least one sensor module 1 and said at least one functional module 20 are arranged partly in said interior space 25. From FIG. 7 it can be seen that the engagement structure 7 of the sensor module 1 engage with the frame side engagement structure 23. The frame side engagement structure 23 is a groove into which the engagement structure 7 of the sensor module 1, here in the shape of an embossment engages. Likewise, the functional module 20 has an engagement structure which engages with the frame side engagement structure 23.

The functional module 20 comprises a front side 26, which defines a connection plane P, wherein a front wall 14 of the carrier housing 3 extends in said plane.

The modular connector further comprises a connector housing, wherein the printed circuit board extends into the connector housing.

The corresponding modular connector C2 has preferably a similar structure as the modular connector C1. However, at the location of the sensor module 1, the corresponding modular connector C2 comprises at least one blind module 27. Such a blind module 27 does not have any particular electrical or fluidic function and serves mainly as distance holder between the functional modules in the corresponding modular connector C2. The blind module 27 is connected in a similar manner to the frame element 23 of the corresponding modular connector C2 as the sensor module 1 to the frame element 23 of the modular connector C1.

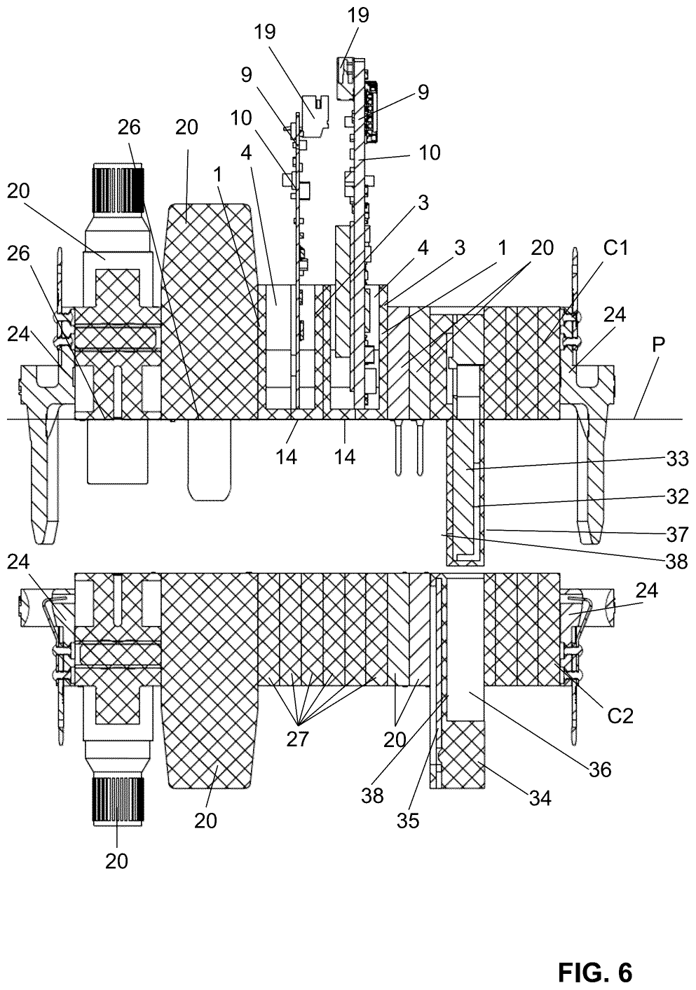

FIGS. 5 and 6 also shows an identification arrangement in connection with the modular connector C1 and the corresponding modular connector C2.

The identification arrangement comprises a first carrier housing 32 and a second carrier housing 33. The first carrier housing 32 is mounted to the modular connector C1 and the second carrier housing 33 is mounted to the corresponding modular connector C2. The first carrier housing 32 is provided with an active identification device 33 and the second carrier housing 34 is provided with a passive identification device 35. The active identification device 33 is configured to identify the passive identification device 35. One of said carrier housings 32, 34, in the figures the second carrier housing 34 has a recess 36 and the other of said carrier housings 34, 32, in the figures the first carrier housing 32 has a shaft 37. The shaft 37 and the recess 36 are configured such that the shaft 37 can be inserted into and received by the recess 36. Furthermore, each of said carrier housing comprises an engagement structure 7. The engagement structure can be provided in a similar manner as the engagement structure as outline with the carrier housing in which the printed circuit board is arranged.

The active identification device 33 and the passive identification device 35 are arranged such on the respective carrier housing 32, 34 that identification becomes only possible, when the shaft 37 is fully inserted into the recess 36 or such that identification becomes possible during insertion of the shaft 37 into the recess 36.

As it can be seen from the figures, in particular from FIG. 6, the first carrier housing 32 and the second carrier housing 34 have at least one wall 6 which at least partly delimits a receiving space 4. The at least one wall has an outer surface 38, which outer surface 38 of said first carrier housing 32 and which outer surface 38 of said second carrier housing 34 are in a flat engagement when the shaft 37 is fully inserted into the recess 36. The identification devices 33, 35 are arranged in the receiving space 4 behind said outer surfaces 38.

LIST OF REFERENCE SIGNS

| | | | |
|---|---|---|---|
| 1 | sensor module | 33 | active identification device |
| 3 | carrier housing | 34 | second carrier housing |
| 4 | receiving space | 35 | passive identification device |
| 5 | opening | 36 | recess |
| 6 | wall | 37 | shaft |
| 7 | engagement structure | 38 | outer surface |
| 8 | outer side | C1 | modular connector |
| 9 | sensor element | C2 | corresponding modular |
| 10 | printed circuit board | | connector |
| 11 | sensor | P | plane |
| 12 | first section | | |
| 13 | second section | | |
| 14 | front wall | | |
| 15 | sidewalls | | |
| 16 | first carrier housing part | | |
| 17 | second carrier housing part | | |
| 18 | connection element | | |
| 19 | communication module | | |
| 20 | functional module | | |
| 21 | bearing frame | | |
| 22 | frame elements | | |
| 23 | a frame side engagement | | |
| | structure | | |
| 24 | connection elements | | |
| 25 | interior space | | |
| 26 | front side | | |
| 27 | blind module | | |
| 28 | screw | | |
| 29 | nut | | |
| 30 | embossment | | |
| 31 | indentation | | |
| 32 | first carrier housing | | |

1-17. (canceled)

18. Sensor module for a modular connector, comprising
a carrier housing with a receiving space that is accessible via an opening and that is closed with walls and with an engagement structure arranged on the outer side of the carrier housing, and
a sensor element comprising a printed circuit board and at least one sensor to measure a physical property, wherein the at least one sensor is arranged on the printed circuit board,
wherein said printed circuit board is mounted within the receiving space to the carrier housing and extends from the receiving space through the opening out of the receiving space.

19. Sensor module according to claim 18, wherein the printed circuit board extends with a first section into the receiving space and with a second section out of the receiving space, wherein as seen perpendicular to the side of the carrier housing in which the opening is placed, the length of the first section is smaller or larger or equal compared to the length of the second section.

20. Sensor module according to claim 19, wherein at least one of said sensors is arranged on the first section and/or wherein at least one of said sensor elements is arranged on the second section.

21. Sensor module according to claim 20, wherein said walls comprise a front wall and sidewalls extending from said front wall, wherein the opening is encompassed by said sidewalls.

22. Sensor module according to claim 20, wherein said walls comprise a front wall and sidewalls extending from said front wall, wherein the opening is encompassed by said sidewalls, wherein the front wall has a rectangular form and/or wherein said sidewalls extend perpendicularly to said front wall.

23. Sensor module according to claim 18, wherein said carrier housing is provided with a first carrier housing part and with a second carrier housing part,
or wherein said carrier housing is provided as a single piece element.

24. Sensor module according to claim 18, wherein said carrier housing is provided with a first carrier housing part and with a second carrier housing part, wherein the first carrier housing part and the second carrier housing part are connected together by means of at least one connection element.

25. Sensor module according to claim 18, wherein the printed circuit board is mounted by means of a form fit and/or a force fit connection with the carrier housing.

26. Sensor module according to claim 18, wherein the printed circuit board comprises at least one a communication module, wherein said communication module is a mechanical connection interface to connect a connector of a signal cable and/or said communication module is a wireless communication module;
and/or wherein the printed circuit board comprises a micro controller and/or a battery.

27. Sensor module according to claim 26, wherein said at least one communication module is located outside the receiving space.

28. Sensor module according to claim 18, wherein a first engagement structure is arranged on a first wall of said walls and a second engagement structure is arranged on a second wall of said walls, which second wall is arranged opposite the first wall.

29. Sensor module according to claim 18, wherein the at least one sensor is chosen from the group of
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or
an acceleration sensor configured to measure an acceleration, which is said physical property; and/or
an mating cycle sensor configured to measure the number of mating cycles, which are said physical property; and/or
a flow sensor configured to measure a volume flow, which is said physical property.

30. Sensor module according to claim 18, wherein the sensor module is provided for a modular electrical and/or fluidic connector.

31. Identification arrangement for a modular connector, comprising a first carrier housing with an active identification device and a second carrier housing with a passive identification device, wherein the active identification device is configured to identify the passive identification device,
wherein one of said carrier housings has a recess and the other of said carrier housings has a shaft, wherein the shaft and the recess are configured such that the shaft can be inserted into and received by the recess; and
wherein each of said carrier housing comprises an engagement structure.

32. Identification arrangement according to claim 31, wherein the active identification device and the passive identification device are arranged such on the respective carrier housing that identification becomes only possible, when the shaft is fully inserted into the recess; or wherein the active identification device and the passive identification device are arranged such on the respective carrier housing that identification becomes possible during the insertion of the shaft into the recess.

33. Identification arrangement according to claim 31, wherein the first carrier housing and the second carrier housing have at least one wall at least partly delimiting a receiving space, wherein the at least one wall has an outer surface, which outer surface of said first carrier housing and which outer surface of said second carrier housing are in a flat engagement when the shaft is fully inserted into the recess or during insertion of the shaft into the recess, wherein said identification devices are arranged in the receiving space behind said outer surfaces.

34. Identification arrangement according to claim 31, wherein the modular connector is a modular electrical and/or fluidic connector.

35. Modular connector comprising
at least one sensor module comprising a carrier housing with a receiving space that is accessible via an opening and that is closed with walls and with an engagement structure arranged on the outer side of the carrier housing, and a sensor element comprising a printed circuit board and at least one sensor to measure a physical property, wherein the at least one sensor is arranged on the printed circuit board, wherein said printed circuit board is mounted within the receiving space to the carrier housing and extends from the receiving space through the opening out of the receiving space;
and/or
at least one of a carrier housing chosen from a first carrier housing with an active identification device and from a second carrier housing with a passive identification device, wherein the active identification device is configured to identify the passive identification device;
wherein said modular connector further comprises
at least one functional module and
a bearing frame having two frame elements with a frame side engagement structure and two connection elements, which frame elements and connection elements are arranged such to form an interior space,
wherein said at least one functional module is arranged partly in said interior space and the engagement structure of the functional module engages with the frame side engagement structure,
wherein if present said at least one sensor module is arranged partly in said interior space and the engagement structure of the sensor module engages with the frame side engagement structure; and
wherein if present said carrier housing is arranged partly in said interior space and the engagement structure of the carrier housing engages with the frame side engagement structure.

36. Modular connector according to claim 35, wherein the functional module comprises a front side which defines a connection plane, wherein a front wall of the carrier housing extends in said plane; and/or wherein the shaft of the first carrier housing or the second carrier housing, respectively extends away from said plane.

37. Modular connector according to claim 35, further comprising a connector housing, wherein the printed circuit board extends into the connector housing.

38. Modular connector according to claim 35, wherein when the at least one sensor module and the at least one carrier housing are present, the active identification device is electrically connected to the at least one printed circuit board.

39. Connector system comprising a modular connector according to claim 35 and a corresponding modular connector having at least one functional module which can be connected to the functional module of the modular connector,
wherein at the corresponding position of the at least one sensor module, if present, at least one blind module is placed; and/or
wherein at the corresponding position of the at least one carrier housing, if present, said at least one other carrier housing is placed.
